(19) United States
(12) Patent Application Publication
(10) Pub. No.: US 2020/0269333 A1
(43) Pub. Date: Aug. 27, 2020

(54) FORM CUTTING METHOD

(71) Applicant: MITSUBISHI HEAVY INDUSTRIES COMPRESSOR CORPORATION, Tokyo (JP)

(72) Inventor: Shinji Takemoto, Hiroshima-shi (JP)

(73) Assignee: MITSUBISHI HEAVY INDUSTRIES COMPRESSOR CORPORATION, Tokyo (JP)

(21) Appl. No.: 16/793,595

(22) Filed: Feb. 18, 2020

(30) Foreign Application Priority Data
Feb. 22, 2019 (JP) 2019-030622

(51) Int. Cl. B23C 3/30

(52) U.S. Cl. CPC B23C 3/30; B23C 2220/366

(57) ABSTRACT

A form cutting method includes a first cutting step of moving a semi-finishing tool having a first cutting edge in a tool feeding direction Dt orthogonal to a first axis while rotating the semi-finishing tool in a first direction about the axis to form a blade groove 120 having a contour shape of the semi-finishing tool and being continuous in the tool feeding direction Dt on a workpiece 100, and a second cutting step of moving a final finishing tool 20 having a second cutting edge 24s opposite to the semi-finishing tool in the tool feeding direction Dt while rotating the final finishing tool in a second direction R2 about a second axis O2 to finish groove inner peripheral surfaces 120x and 120y of the blade groove 120.

### BACKGROUND OF THE INVENTION

### Field of the Invention

The present invention relates to a form cutting method.

Priority is claimed on Japanese Patent Application No. 2019-030622, filed on Feb. 22, 2019, the content of which is incorporated herein by reference.

### Description of Related Art

When machining metal parts or the like constituting various devices, form cutting may be used. In form cutting, a tool having a predetermined contour is used to cut a workpiece into the same shape as the contour of the tool. In order to carry out machining by such form cutting, first, a semi-finishing tool having a predetermined contour shape is moved around a tool axis in a tool feeding direction orthogonal to the axis while rotating around the tool axis to cut a metal workpiece. As a result, a form groove that has the same shape as the contour shape of the tool and is continuous in the tool feeding direction is formed on the workpiece. Next, finishing is performed using a finishing tool. In this finishing, while rotating the finishing tool about the axis, the tool is moved in a direction orthogonal to the axis to slightly scrape the inner peripheral surface of the form groove. Thereby, in the finishing, the form groove is finished with a predetermined dimensional accuracy.

As described above, when machining is performed using a semi-finishing tool or a finishing tool, burrs protruding from the inner peripheral edge portion of the form groove are generated on the downstream end surface of the workpiece in the tool feeding direction. A lot of labor and cost are required to remove the burr manually by using a file or the like.

On the other hand, for example, PCT International Publication No. WO2012/073374 discloses a configuration for carrying out chamfering to remove the burrs on the end surface for the workpiece. Specifically, after forming a form groove with a tool having a predetermined contour shape, chamfering is performed by using a rotary cutting tool for chamfering.

### SUMMARY OF THE INVENTION

However, in the configuration disclosed in PCT International Publication No. WO2012/073374, it is necessary to add a step of chamfering using a tool only for removing burrs after performing finishing. As a result, the number of man-hours is increased, and the machining time for forming the form groove is increased.

The present invention provides a form cutting method capable of suppressing an increase in machining time for forming a form groove.

According to a first aspect of the invention, there is provided a form cutting method includes a first cutting step of moving a first form cutting tool having a first cutting edge in a tool feeding direction orthogonal to an axis while rotating the first form cutting tool in a first direction about the axis to form a form groove having a contour shape of the first form cutting tool and being continuous in the tool feeding direction on a workpiece, and a second cutting step of moving a second form cutting tool having a second cutting edge opposite to the first form cutting tool in the tool feeding direction while rotating the second form cutting tool in a second direction about the axis, which is opposite to the first direction, to finish an inner peripheral surface of the form groove.

With such a configuration, when the first form cutting tool is rotated in the first direction to form the form groove, burrs protruding from the inner peripheral surface of the form groove in the moving direction of the tool are generated. Then, when the second form cutting tool is rotated in the second direction opposite to the first direction to finish the inner peripheral surface of the form groove, the burr is removed from the direction opposite to the direction in which the burr protrudes by the second cutting edge (for example, outer peripheral cutting edge) of the second form cutting tool. In this manner, burrs can be simultaneously removed with the second form cutting tool that finishes the inner peripheral surface of the form groove. On the other hand, although burrs are generated on the side opposite to the first cutting step, they are minute in accordance with the finishing allowance. For this reason, it is possible to significantly reduce or omit the time for removing the burrs after finishing the inner peripheral surface of the form groove. Therefore, it is possible to suppress the occurrence of burrs while suppressing an increase in the machining time.

Further, in the form cutting method according to a second aspect of the invention, in the first aspect, the first form cutting tool may be a right-hand milling tool, the second form cutting tool may be a left-hand milling tool, the first direction may be a clockwise direction, and the second direction may be a counterclockwise direction.

With such a configuration, with two types of form cutting tools, a first form cutting tool with a first cutting edge and a second form cutting tool with a second cutting edge, it is possible to process the form groove including deburring.

According to the present invention, it becomes possible to suppress the increase in the machining time for forming a form groove.

### BRIEF DESCRIPTION OF THE DRAWINGS

FIG. 1 is a plan view showing a workpiece having a blade groove formed by using a form cutting method according to an embodiment of the present invention.

FIG. 2 is a plan view showing a semi-finishing tool used in a semi-finishing step of the form cutting method according to the embodiment.

FIG. 3 is a view showing the semi-finishing tool used in the semi-finishing step of the form cutting method according to the embodiment, and is a cross-sectional view taken along line A-A of FIG. 2.

FIG. 4 is a plan view showing a final finishing tool used in a final finishing step of the form cutting method according to the embodiment.

FIG. 5 is a view showing the final finishing tool used in the final finishing step of the form cutting method according to the embodiment, and is a cross-sectional view taken along line B-B of FIG. 4.

FIG. 6 is a flowchart showing a flow of the form cutting method according to the embodiment.

FIG. 7 is a cross-sectional view showing a state in which a workpiece is being cut using a semi-finishing tool in the semi-finishing step in the form cutting method according to the embodiment.

FIG. 8 is a cross-sectional view showing a state in which a workpiece is being cut using a final finishing tool in a final finishing step in the form cutting method according to the embodiment.

### DETAILED DESCRIPTION OF THE INVENTION

Hereinafter, an embodiment for carrying out a form cutting method according to the present invention will be described with reference to the accompanying drawings. However, the present invention is not limited to only these embodiments.

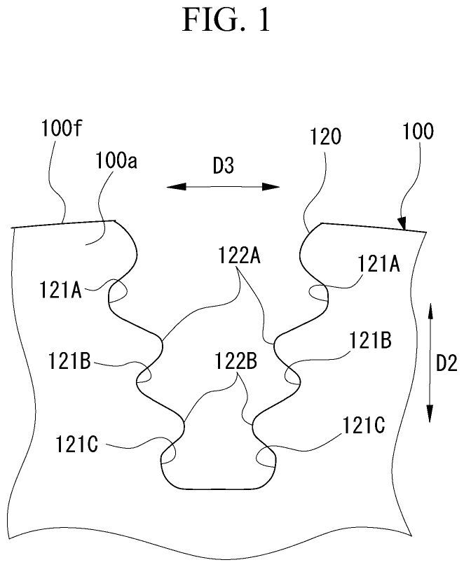

FIG. 1 is a plan view showing a workpiece having a blade groove formed by using a form cutting method according to an embodiment of the present invention. As shown in FIG. 1, a blade groove (form groove) 120 is formed on a workpiece 100 by form cutting method of the present embodiment.

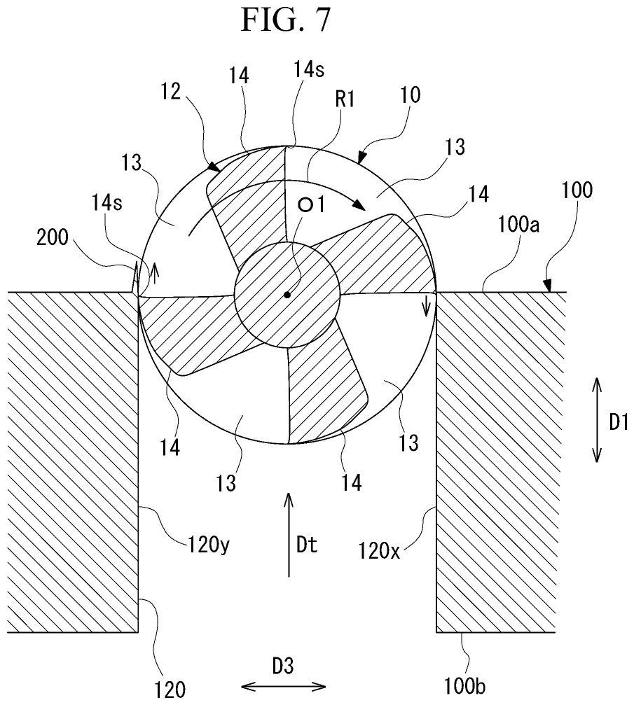

The workpiece 100 is a member that forms a disk portion of a rotor that supports a moving blade or the like of a steam turbine or a gas turbine. The workpiece 100 is a disk-shaped member made of metal and having a fixed thickness. The workpiece 100 includes a first end surface 100a, a second end surface 100b facing the opposite side of the first end surface 100a (see FIG. 7), and an outer peripheral surface 100f connecting the first end surface 100a and the second end surface 100b.

The blade groove 120 is a groove into which a blade root (not shown) provided at a base portion of a moving blade or the like of a steam turbine or a gas turbine is fitted. The blade groove 120 is formed so as to be depressed from the outer peripheral surface 100f of the workpiece 100 toward the inside of the workpiece 100.

In the following description, a direction orthogonal to the first end surface 100a and the second end surface 100b of the workpiece 100 (the direction orthogonal to the paper of FIG. 1) is referred to as a thickness direction D1 of the workpiece 100 (see FIG. 7). Further, a direction orthogonal to the thickness direction D1 and orthogonal to the outer peripheral surface 100f of the workpiece 100, and a direction in which the blade groove 120 is depressed from the outer peripheral surface 100f is referred to as a depth direction D2 of the blade groove 120. Furthermore, a direction orthogonal to the thickness direction D1 and the depth direction D2 is referred to as a groove width direction D3 of the blade groove 120.

The blade groove 120 has a Christmas tree shape corresponding to the outer peripheral shape of the blade root (not shown). Specifically, the blade groove 120 has a first engagement recessed portion 121A, a second engagement recessed portion 121B, and a third engagement recessed portion 121C at intervals in the depth direction D2. The first engagement recessed portion 121A, the second engagement recessed portion 121B, and the third engagement recessed portion 121C each have a curved shape depressed toward both sides in the groove width direction D3. Here, the dimension of depression in the first engagement recessed portion 121A, the second engagement recessed portion 121B, and the third engagement recessed portion 121C in the groove width direction D3 increases in the order of the first engagement recessed portion 121A closest to the outer peripheral surface 100f of the workpiece 100, the second engagement recessed portion 121B inside of the workpiece 100, and the third engagement recessed portion 121C from the first engagement recessed portion 121A in the depth direction D2.

A first engagement projecting portion 122A is formed between the first engagement recessed portion 121A and the second engagement recessed portion 121B that are adjacent to each other in the depth direction D2. Further, a second engagement projecting portion 122B is formed between the second engagement recessed portion 121B and the third engagement recessed portion 121C that are adjacent to each other in the depth direction D2. The first engagement projecting portion 122A and the second engagement projecting portion 122B are curved and protrude inward in the groove width direction D3 in the blade groove 120.

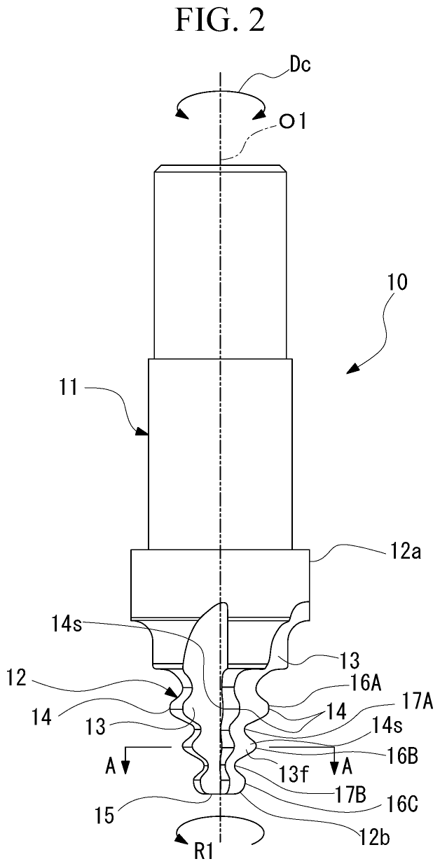

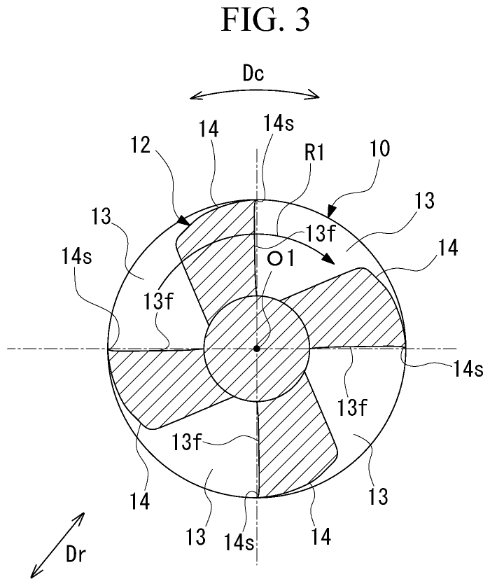

FIG. 2 is a plan view showing a semi-finishing tool used in a semi-finishing step of the form cutting method. FIG. 3 is a view showing the semi-finishing tool used in the semi-finishing step of the form cutting method according to the embodiment, and is a cross-sectional view taken along line A-A of FIG. 2.

As shown in FIGS. 2 and 3, a semi-finishing tool (first form cutting tool) 10 is a forming milling tool used for form cutting. The semi-finishing tool 10 includes a first shank portion 11 and a first tool body portion 12. The semi-finishing tool 10 is formed from high speed steel or cemented carbide for the tool.

The first shank portion 11 has a columnar shape or a truncated cone shape extending in the direction of a first axis (axis) O1 extending from the first axis O1 around the first axis O1. The first shank portion 11 is held on a main shaft (not shown) of a machine tool for performing milling. The semi-finishing tool 10 is driven to rotate in a first direction R1 in a circumferential direction Dc around the first axis O1 while the first shank portion 11 is held on the main shaft of the machine tool. In the semi-finishing tool 10 of the present embodiment, when viewed from the first shank portion 11 side in the direction of the first axis O1, the first tool body portion 12 is driven to rotate clockwise (right-hand turn). That is, in the present embodiment, the first direction R1, which is the tool rotation direction of the semi-finishing tool 10, is a clockwise direction.

The first tool body portion 12 is provided continuously from the first shank portion 11 in the direction of the first axis O1. The first tool body portion 12 extends in the direction of the first axis O1 from a first base end portion 12a on the side close to the first shank portion 11 toward a first tip end portion 12b on the side away from the first shank portion 11. The first tool body portion 12 has a Christmas tree shape corresponding to the blade groove 120 to be formed. The first tool body portion 12 has a first chip discharge groove 13, a first outer peripheral cutting edge portion 14, and a first tip cutting edge portion 15.

A plurality of first chip discharge grooves 13 are formed on the outer peripheral portion of the first tool body portion 12 at intervals in the circumferential direction Dc around the first axis O1. In the present embodiment, for example, four first chip discharge grooves 13 are provided at equal intervals in the circumferential direction Dc. Each first chip discharge groove 13 extends continuously from the first base end portion 12a toward the first tip end portion 12b. Each first chip discharge groove 13 is recessed toward the center of the first tool body portion 12 in a radial direction Dr.

The first outer peripheral cutting edge portion 14 is formed adjacent to the first chip discharge groove 13 in the circumferential direction Dc. A plurality of first outer peripheral cutting edge portions 14 are provided on the outer peripheral portion of the first tool body portion 12 at intervals in the circumferential direction Dc around the first axis O1. Each first outer peripheral cutting edge portion 14 extends continuously from the first base end portion 12a toward the first tip end portion 12b along the direction of the first axis O1. In the semi-finishing tool 10 driven to rotate in the clockwise first direction R1, a first cutting edge (for example, an outer peripheral cutting edge) 14s is formed in front of the first direction R1, which is the rotation direction of each first outer peripheral cutting edge portion 14. The first cutting edge 14s protrudes forward in the first direction R1. In each first chip discharge groove 13, a surface located rearward in the first direction R1 and facing forward in the rotation direction forms a first rake surface 13f of chips cut by the first cutting edge 14s. Thereby, when the semi-finishing tool 10 rotates in the first direction R1, the workpiece 100 is cut by the first cutting edge 14s facing forward in the first direction R1. That is, the first cutting edge 14s is a right-hand cutting edge that cuts the workpiece 100 when rotated in the first direction R1.

In the semi-finishing tool 10, the first outer peripheral cutting edge portion 14 and the first tip cutting edge portion 15 have the same contour as the blade groove 120 to be formed on the workpiece 100. Specifically, as shown in FIG. 2, each first outer peripheral cutting edge portion 14 has a first large diameter portion 16A, a second large diameter portion 16B, and a third large diameter portion 16C from the first base end portion 12a toward the first tip end portion 12b. The first large diameter portion 16A, the second large diameter portion 16B, and the third large diameter portion 16C are each formed to protrude from the first axis O1 in the radial direction Dr. The first large diameter portion 16A forms a first engagement recessed portion 121A of the blade groove 120 (see FIG. 1). The second large diameter portion 16B forms a second engagement recessed portion 121B. The third large diameter portion 16C forms a third engagement recessed portion 121C. Each first outer peripheral cutting edge portion 14 has a first small diameter portion 17A between the first large diameter portion 16A and the second large diameter portion 16B in the direction of the first axis O1. Each first outer peripheral cutting edge portion 14 has a second small diameter portion 17B between the second large diameter portion 16B and the third large diameter portion 16C in the direction of the first axis O1. The first small diameter portion 17A and the second small diameter portion 17B are each curved and depressed in the radial direction Dr.

The first tip cutting edge portion 15 is formed on the first tip end portion 12b. The first tip cutting edge portion 15 is formed so as to be continuous with the first outer peripheral cutting edge portion 14. The first tip cutting edge portion 15 is orthogonal to the direction of the first axis O1.

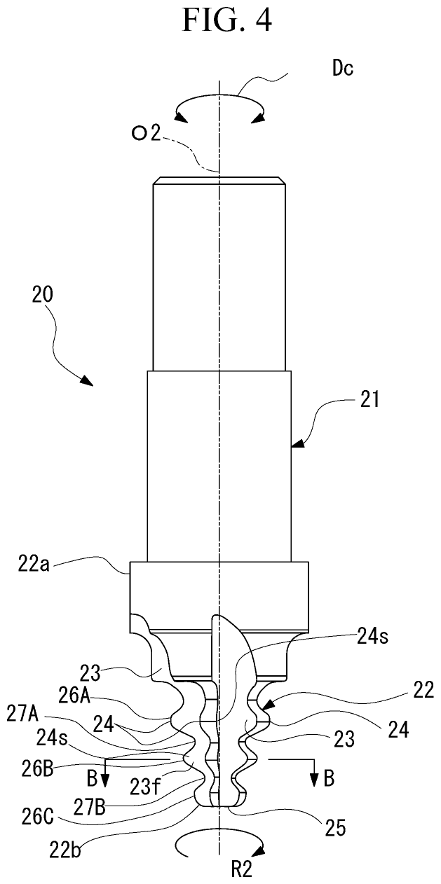

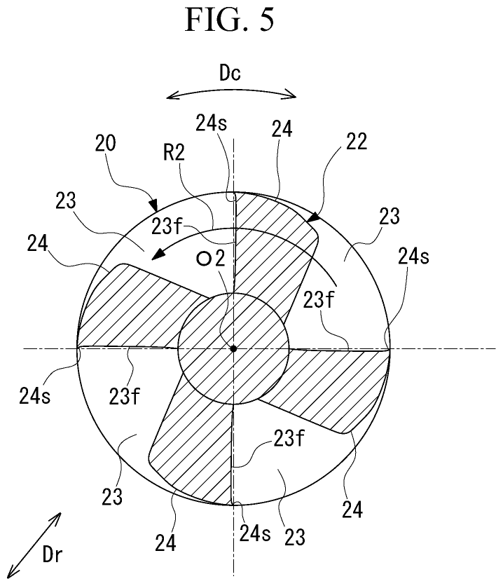

FIG. 4 is a plan view showing a final finishing tool used in a final finishing step of the form cutting method. FIG. 5 is a view showing the final finishing tool used in the final finishing step of the form cutting method, and is a cross-sectional view taken along line B-B of FIG. 4.

As shown in FIGS. 4 and 5, the final finishing tool (second form cutting tool) 20 is a forming milling tool used for form cutting. The final finishing tool 20 includes a second shank portion 21 and a second tool body portion 22. The final finishing tool 20 is formed from high speed steel or cemented carbide for the tool.

The second shank portion 21 is formed in a columnar shape or a truncated cone shape extending in the direction of a second axis (axis) O2 extending from the second axis O2 around the second axis O2. The second shank portion 21 is held on a main shaft (not shown) of a machine tool for performing milling. The final finishing tool 20 is driven to rotate in a second direction R2 in the circumferential direction Dc around the second axis O2 while the second shank portion 21 is held on the main shaft of the machine tool. In the final finishing tool 20 of the present embodiment, when viewed from the second shank portion 21 side in the direction of the second axis O2, the second tool body portion 22 is driven to rotate counterclockwise in a direction opposite to the first direction R1 (left-hand turn). That is, in the present embodiment, the second direction R2 that is the tool rotation direction of the final finishing tool 20 is a counterclockwise direction.

The second tool body portion 22 is provided continuously from the second shank portion 21 in the direction of the second axis O2. The second tool body portion 22 extends in the direction of the second axis O2 from a second base end portion 22a on the side closer to the second shank portion 21 toward a second tip end portion 22b on the side away from the second shank portion 21. The second tool body portion 22, like the first tool body portion 12, has a Christmas tree shape corresponding to the blade groove 120 to be formed. The second tool body portion 22 has a second chip discharge groove 23, a second outer peripheral cutting edge portion 24, and a second tip cutting edge portion 25.

A plurality of second chip discharge grooves 23 are formed on the outer peripheral portion of the second tool body portion 22 at intervals in the circumferential direction Dc around the second axis O2. In the present embodiment, for example, four second chip discharge grooves 23 are provided at equal intervals in the circumferential direction Dc. Each second chip discharge groove 23 extends continuously from the second base end portion 22a toward the second tip end portion 22b. Each second chip discharge groove 23 is recessed toward the center of the second tool body portion 22 in the radial direction Dr.

A plurality of second outer peripheral cutting edge portions 24 are formed on the outer peripheral portion of the second tool body portion 22 at intervals in the circumferential direction Dc around the second axis O2. The second outer peripheral cutting edge portion 24 is provided adjacent to the second chip discharge groove 23 in the circumferential direction Dc. Each second outer peripheral cutting edge portion 24 extends continuously from the second base end portion 22a toward the second tip end portion 22b along the direction of the second axis O2. In the final finishing tool 20 which is driven to rotate in the counterclockwise second direction R2, a second cutting edge (for example, an outer peripheral cutting edge) 24s is formed in front of the second direction R2, which is the rotation direction of the second outer peripheral cutting edge portion 24. The second cutting edge 24s protrudes forward in the second direction R2. In each second chip discharge groove 23, a surface located rearward in the second direction R2 and facing forward in the rotation direction forms a second rake surface 23f of the chips cut by the second cutting edge 24s. Thereby, when the final finishing tool 20 rotates in the second direction R2, the workpiece 100 is cut by the second cutting edge 24s facing forward in the second direction R2. That is, the second cutting edge 24s is a left-hand cutting edge opposite to the first cutting edge 14s of the semi-finishing tool 10.

As shown in FIG. 4, each second outer peripheral cutting edge portion 24 has a first large diameter portion for finishing 26A, a second large diameter portion for finishing 26B, and a third large diameter portion for finishing 26C from the second base end portion 22a toward the second tip end portion 22b. The first large diameter portion for finishing 26A, the second large diameter portion for finishing 26B, and the third large diameter portion for finishing 26C are each formed to protrude from the second axis O2 in the radial direction Dr. The first large diameter portion for finishing 26A is used to finish the first engagement recessed portion 121A of the blade groove 120 (see FIG. 1). The second large diameter portion for finishing 26B is used to finish the second engagement recessed portion 121B. The third large diameter portion for finishing 26C finishes the third engagement recessed portion 121C. Each second outer peripheral cutting edge portion 24 has a first small diameter portion for finishing 27A between the first large diameter portion for finishing 26A and the second large diameter portion for finishing 26B in the direction of the second axis O2. Each second outer peripheral cutting edge portion 24 has a second small diameter portion for finishing 27B between the second large diameter portion for finishing 26B and the third large diameter portion for finishing 26C in the direction of the second axis O2. The first small diameter portion for finishing 27A and the second small diameter portion for finishing 27B are each curved and depressed in the radial direction Dr.

The second tip cutting edge portion 25 is formed on the second tip end portion 22b. The second tip cutting edge portion 25 is formed so as to be continuous with the second outer peripheral cutting edge portion 24. The second tip cutting edge portion 25 is orthogonal to the direction of the second axis O2.

In such a final finishing tool 20, the second outer peripheral cutting edge portion 24 and the second tip cutting edge portion 25 are formed in the same contour (same dimension) as the blade groove 120 to be formed on the workpiece 100. That is, the final finishing tool 20 has the same shape as the semi-finishing tool 10. The final finishing tool 20 may be formed so as to have a slightly larger outer dimension (for example, about 0.1 to 0.2 mm) than the semi-finishing tool 10.

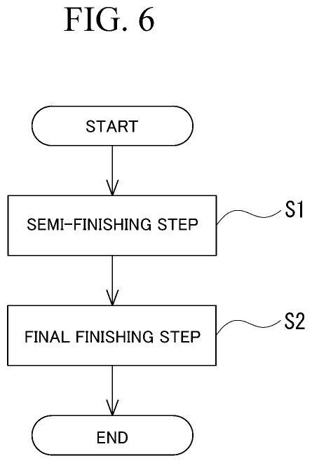

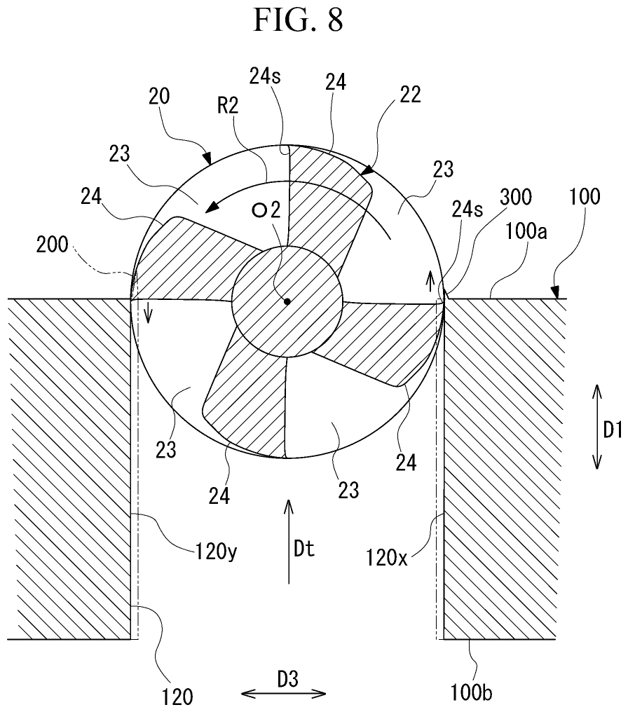

Next, a description will be given of the form cutting method according to the present embodiment. FIG. 6 is a flowchart showing a flow of the form cutting method. FIG. 7 is a cross-sectional view showing a state in which a workpiece is being cut using a semi-finishing tool in the semi-finishing step in the form cutting method. FIG. 8 is a cross-sectional view showing a state in which a workpiece is being cut using a final finishing tool in a final finishing step in the form cutting method.

As shown in FIG. 6, the form cutting method in the present embodiment includes a semi-finishing step (first cutting step) S1 and a final finishing step (second cutting step) S2.

As shown in FIG. 7, in the semi-finishing step S1, the semi-finishing tool 10 is mounted in a state where the axis of the main shaft and the first axis O1 are aligned with the main shaft (not shown) of the machine tool. When the main shaft rotates in the first direction R1, the semi-finishing tool 10 is moved in the tool feeding direction Dt orthogonal to the first axis O1, while being rotated in the first direction R1 around the first axis O1. As a result, the Christmas tree-shaped blade grooves 120 are cut on the workpiece 100 on which the blade grooves 120 are not formed. Here, the tool feeding direction Dt is the thickness direction D1 of the workpiece 100, and is a direction from the second end surface 100b to the first end surface 100a. That is, the tool feeding direction Dt is a direction parallel to the blade groove (form groove) 120 to be formed. Thereby, the blade groove 120 having the contour shape of the semi-finishing tool 10 is continuously formed on the workpiece 100 in the tool feeding direction Dt. A groove inner peripheral surface 120x and a groove inner peripheral surface 120y in the blade groove 120 formed in the semi-finishing step S1 have extremely large surface roughness (rough state).

On the workpiece 100, the first cutting edge 14s of the semi-finishing tool 10 that rotates in the first direction R1 performs cutting on the groove inner peripheral surface (inner peripheral surface) 120x on a first side in the groove width direction D3 from the first end surface 100a toward the second end surface 100b. On the other hand, the first cutting edge 14s performs cutting on the groove inner peripheral surface (inner peripheral surface) 120y on the second side in the groove width direction D3 from the second end surface 100b toward the first end surface 100a. The semi-finishing tool 10 is moved from the second end surface 100b toward the first end surface 100a along the thickness direction D1. Therefore, a burr 200 protrudes from the groove inner peripheral surface 120y on the second side in the groove width direction D3 toward the outside in the thickness direction D1 (tool feeding direction Dt) on the first end surface 100a of the workpiece 100.

The final finishing step S2 is performed after the semi-finishing step S1. As shown in FIG. 8, in the final finishing step S2, the final finishing tool 20 is mounted in a state where the axis of the main shaft and the second axis O2 are aligned with the main shaft (not shown) of the machine tool. By rotating the main shaft in the second direction R2, the final finishing tool 20 is moved in the tool feeding direction Dt while being rotated in the second direction R2 around the second axis O2. As a result, the groove inner peripheral surface 120x and the groove inner peripheral surface 120y formed on the workpiece 100 are further cut by the final finishing tool 20 so that the surfaces are adjusted. Accordingly, the blade groove 120 having a final shape with a small surface roughness of the groove inner peripheral surface 120x and the groove inner peripheral surface 120y is continuously formed on the workpiece 100 in the tool feeding direction Dt.

The second cutting edge 24s of the final finishing tool 20 that rotates in the second direction R2 performs a cutting process on the groove inner peripheral surface 120x on the first side in the groove width direction D3 from the second end surface 100b toward the first end surface 100a. On the other hand, the second cutting edge 24s performs cutting from the first end surface 100a to the second end surface 100b on the groove inner peripheral surface 120y on the second side in the groove width direction D3. The final finishing tool 20 is moved from the second end surface 100b to the first end surface 100a along the tool feeding direction Dt. Thereby, the groove inner peripheral surface 120x and the groove inner peripheral surface 120y formed by the semi-finishing tool 10 are cut, for example, by about 0.1 to 0.2 mm. Then, when the final finishing tool 20 exits outside the first end surface 100a in the tool feeding direction Dt, the final finishing tool 20 also scrapes off the burr 200 formed on the first end surface 100a. On the other hand, on the first end surface 100a of the workpiece 100, a minute burr 300 protrudes outward from the groove inner peripheral surface 120x on the second side in the groove width direction D3 in the thickness direction D1 (tool feeding direction Dt). However, the minute burr 300 is extremely small compared to the burr 200, and is small enough to be easily removed by maintenance (manual operation without using a tool) or to omit the removal.

According to the above-described form cutting method, first, the semi-finishing tool 10 having the first cutting edge 14s is rotated in the first direction R1 to form the blade groove 120 on the workpiece 100. After that, the final finishing tool 20 having the second cutting edge 24s opposite to the first cutting edge 14s is rotated in the second direction R2 opposite to the semi-finishing tool 10 to further cut the groove inner peripheral surface 120x and the groove inner peripheral surface 120y forming the blade groove 120. Thereby, the blade groove 120 is finished. At that time, the burr 200 generated when the blade groove 120 is formed by the semi-finishing tool 10 is scraped off so as to be caught by the second cutting edge 24s rotating in the second direction R2 as the final finishing tool 20 passes. Therefore, the burr 200 can be removed at the same time by the final finishing tool 20 for finishing the groove inner peripheral surface 120x and the groove inner peripheral surface 120y of the blade groove 120. That is, the final finishing of the blade groove 120 and the deburring can be performed simultaneously by the final finishing tool 20. As a result, there is no need to separately remove the burr 200 with a chamfering tool or the like after finishing the blade groove 120. Therefore, there is no need to newly prepare a deburring tool or separately prepare a step for deburring. Therefore, it is possible to remove burrs while suppressing increases in tool cost and machining time.

The semi-finishing tool 10 has a right-hand first cutting edge 14s that cuts the workpiece 100 when rotated in the first direction R1. On the other hand, the final finishing tool 20 has a left-hand second cutting edge 24s that cuts the workpiece 100 when rotated in the second direction R2. With such a configuration, the blade groove 120 can be processed by the two types of tools, the semi-finishing tool 10 and the final finishing tool 20, including deburring.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, in the above-described embodiment, the semi-finishing tool 10 is rotated in the clockwise first direction R1, and the final finishing tool 20 is rotated in the counterclockwise second direction R2, but is not limited to this. The semi-finishing tool 10 may be rotated counterclockwise, and the final finishing tool 20 may be rotated clockwise.

In the above-described embodiment, the tool feeding direction Dt of the semi-finishing tool 10 and the final finishing tool 20 is a direction from the second end surface 100b of the workpiece 100 toward the first end surface 100a, but is not limited to this. The tool feeding direction Dt may be a direction from the first end surface 100a of the workpiece 100 toward the second end surface 100b.

The shapes and configurations of the semi-finishing tool 10 and the final finishing tool 20 used to form the blade groove 120 may be any shapes and configurations other than those described above, as long as they are forming milling tools.

When the shape of the blade groove 120 to be formed is complicated, prior to the semi-finishing step S1 using the semi-finishing tool 10, one or more roughing steps of the blade groove 120 using a roughing tool or the like may be performed. At this time, the semi-finishing tool 10 may be used as a milling tool for roughing. At this time, in the roughing step, for example, only the cutting conditions are made different from the semi-finishing step S1.

Further, in the above-described embodiment, the blade groove 120 is formed on the workpiece 100, but the shape and use of the form groove are not limited at all.

### EXPLANATION OF REFERENCES

10 semi-finishing tool (first form cutting tool)
11 first shank portion
12 first tool body portion
12a first base end portion
12b first tip end portion
13 first chip discharge groove
13f first rake surface
14 first outer peripheral cutting edge portion
14s first cutting edge
15 first tip cutting edge portion
16A first large diameter portion
16B second large diameter portion
16C third large diameter portion
17A first small diameter portion
17B second small diameter portion
20 final finishing tool (second form cutting tool)
21 second shank portion
22 second tool body portion
22a second base end portion
22b second tip end portion
23 second chip discharge groove
23f second rake surface
24 second outer peripheral cutting edge portion
24s second cutting edge
25 second tip cutting edge portion
26A first large diameter portion for finishing
26B second large diameter portion for finishing
26C third large diameter portion for finishing
27A first small diameter portion for finishing
27B second small diameter portion for finishing
100 workpiece
100f outer peripheral surface
100a first end surface
100b second end surface
120 blade groove (form groove)
120x groove inner peripheral surface
120y groove inner peripheral surface
121A first engagement recessed portion
121B second engagement recessed portion
121C third engagement recessed portion
122A first engagement projecting portion
122B second engagement projecting portion
200 burr
D1 thickness direction
D2 depth direction
D3 groove width direction
Dc circumferential direction
Dr radial direction
Dt tool feeding direction
O1 first axis
O2 second axis
R1 first direction
R2 second direction
S1 semi-finishing step (first cutting step)
S2 final finishing step (second cutting step)

What is claimed is:

1. A form cutting method comprising:
a first cutting step of moving a first form cutting tool having a first cutting edge in a tool feeding direction orthogonal to an axis while rotating the first form cutting tool in a first direction about the axis to form a form groove having a contour shape of the first form cutting tool and being continuous in the tool feeding direction on a workpiece; and
a second cutting step of moving a second form cutting tool having a second cutting edge opposite to the first form cutting tool in the tool feeding direction while rotating the second form cutting tool in a second direction about the axis, which is opposite to the first direction, to finish an inner peripheral surface of the form groove.

2. The form cutting method according to claim 1,
wherein the first form cutting tool is a right-hand milling tool,
the second form cutting tool is a left-hand milling tool,
the first direction is a clockwise direction, and
the second direction is a counterclockwise direction.
